(19) United States
(12) Patent Application Publication
(10) Pub. No.: US 2003/0120736 A1
(43) Pub. Date: Jun. 26, 2003

(54) Internet facsimile apparatus

(75) Inventor: Masashi Eguchi, Joyo-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/313,531

(22) Filed: Dec. 6, 2002

(30) Foreign Application Priority Data
Dec. 20, 2001 (JP) 2001-387483

(51) Int. Cl. G06F 15/16

(52) U.S. Cl. 709/206

(57) ABSTRACT

An Internet facsimile apparatus includes an account specification device that accepts at least one of a plurality of accounts set in the Internet facsimile apparatus as a common account, and also accepts a default value as the common account. The Internet facsimile apparatus also includes a communication device that transmits and receives e-mail. E-mails are transmitted and received with a specified account and the common account is used for the transmission of e-mails when the account is not specified.

### BACKGROUND OF THE INVENTION

1. Field of the Invention

The present invention relates to a user-friendly Internet facsimile apparatus, having a plurality of accounts.

2. Description of the Related Art

An Internet facsimile apparatus is capable of transmitting and receiving facsimile by e-mail. Facsimile data is then transmitted and received as an e-mail attachment file. A mailbox can be set up for each user of e-mail. When an e-mail address is “aaa@***.com.jp”, “aaa” is the name (account) of the mailbox. A plurality of mailboxes can be set in one mail server.

So far, the Internet facsimile apparatus does not have a plurality of accounts. Even if a plurality of accounts is set in the Internet facsimile apparatus, a user might forget to specify the account of a receiving device after documents are read with a scanner in the Internet facsimile apparatus. Moreover, a user who does not have an account cannot use the Internet facsimile apparatus.

### SUMMARY OF THE INVENTION

According to the present invention, an Internet facsimile apparatus is capable of transmitting and receiving data with or without specifying an account.

According to the present invention, the received facsimile can be easily delivered via the Internet.

According to the present invention, when the Internet facsimile apparatus receives facsimile from a conventional apparatus such as a G3 or a G4 facsimile machine, the received facsimile can also be delivered automatically.

The present invention relates to an Internet facsimile apparatus that transmits or receives facsimile by e-mail and has a plurality of accounts. The Internet facsimile apparatus includes an account specification device that accepts at least one of the plurality of accounts as a common account and also accepts a default value of the account as the common account when transmitting and receiving an e-mail, and a communication device that transmits and receives the e-mail. The Internet facsimile apparatus transmits and receives the e-mail with a specified account, or the common account is used for the transmission when the account is not specified.

The common account is registered in advance.

The common account is set for a LAN manager.

The Internet facsimile apparatus of the present invention includes an account registration device that accepts input of an account name and registers a new account.

The Internet facsimile apparatus of the present invention includes a list storage device that stores a list of accounts.

The Internet facsimile apparatus of the present invention includes a table wherein an e-mail address of a delivery destination is defined with each account of the list and a delivery device that delivers received e-mails to the e-mail address defined in the table when the communication device receives e-mails.

The Internet facsimile apparatus of the present invention includes a second communication device that transmits and receives facsimile data through a public switched telephone network (PSTN). A delivery destination address of facsimile data received by the second communication device is set in the table for common accounts, and the delivery device delivers facsimile data received through the PSTN to the delivery destination address specified in the common account when the second communication device receives facsimile data.

The Internet facsimile apparatus of the present invention includes a table wherein printing from the facsimile is defined with each account of the list.

The Internet facsimile apparatus of the present invention includes a reception log storage device that stores an e-mail reception log with each account of the list.

The Internet facsimile apparatus of the present invention includes a transmission log storage device that stores an e-mail transmission log with each account of the list.

The Internet facsimile apparatus of the present invention includes a scanner for scanning documents, a start key for starting an operation, and a transmission/reception identification device that instructs the communication device to retrieve unopened e-mails from a mail box corresponded to an account set by the account specification device or the common account without setting a document on the scanner and setting a receiving device when the start key is pressed.

A plurality of accounts can be set in the Internet facsimile apparatus of the present invention, so that users can have their own accounts or their group's account and the Internet facsimile apparatus of the present invention is user-friendlier. Moreover, a common account is set and used when the account is not specified. Thus, the common account is used for the transmission even if a user does not specify the account when transmitting and receiving data, and the Internet facsimile apparatus can operate smoothly.

According to the present invention, as a delivery table is provided for recording a delivery destination (transfer destination) of e-mails received in each account, the delivery destination can be set with each account. In particular, when a facsimile is received from a conventional facsimile apparatus, the facsimile can be delivered automatically by using the delivery table for common accounts.

### BRIEF DESCRIPTION OF THE DRAWINGS

FIG. 1 is a diagram showing an environment of an Internet facsimile apparatus in a preferred embodiment.

FIG. 2 is a block diagram of the Internet facsimile apparatus in the preferred embodiment.

FIG. 3 is a flowchart showing an e-mail transmission and reception algorithm of the Internet facsimile apparatus in the preferred embodiment.

FIG. 4 is a diagram showing a delivery table of the Internet facsimile apparatus in the preferred embodiment.

### DETAILED DESCRIPTION OF THE INVENTION

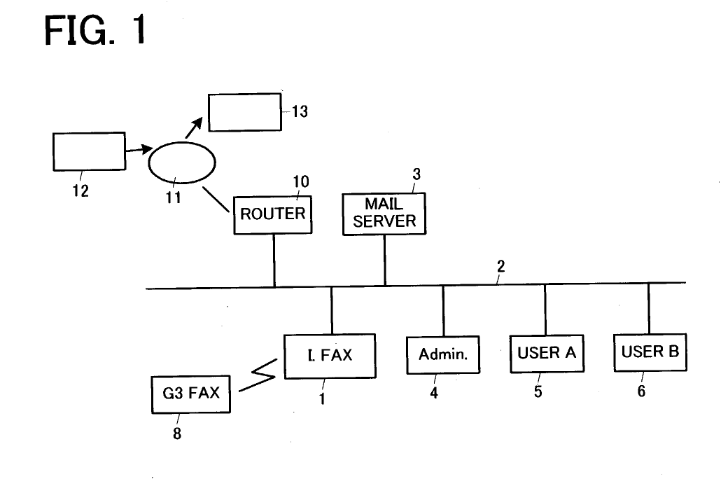

FIG. 1 shows an environment of an Internet facsimile apparatus 1 in a preferred embodiment. In FIG. 1, the Internet facsimile apparatus 1 is shown separately from a mail server 3, however the Internet facsimile apparatus 1 can be also used as the mail server 3. A communication terminal 4 is set for a manager of a LAN 2, and communication terminals 5 and 6 are set for general users A and B. The communication terminals 4˜6 are personal computers.

The Internet facsimile apparatus 1 is connected to a G3 facsimile apparatus 8 through a public switched telephone network (PSTN), and is connected to the Internet 11 through a router 10. The G3 facsimile apparatus 8 is an example of conventional facsimile. It may be that the G3 facsimile apparatus is changed to a G4 facsimile apparatus. A communication terminal 12 is set as a source when transmitting facsimiles to the Internet facsimile apparatus 1, and a communication terminal apparatus 13 is set as a receiving device from the Internet facsimile apparatus 1, both of which are connected to the Internet 11.

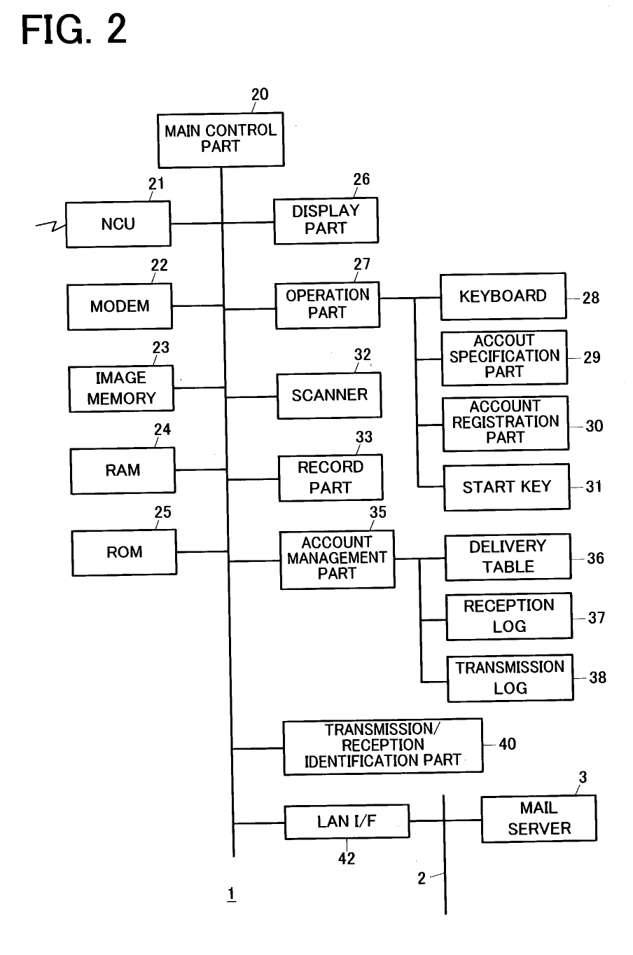

FIG. 2 shows a configuration of the Internet facsimile apparatus 1. A main control part 20 controls the Internet facsimile apparatus 1 entirely. A network control unit (NCU) 21 establishes a connection with the PSTN. Reference number 22 shows a MODEM. An image memory 23 stores facsimile data as image data. A RAM 24 stores data in progress, and a ROM 25 stores a program. A display part 26 shows information using a LED or displays information on a LCD display for users. Users input a destination address such as an e-mail address or a facsimile number with a keyboard 28 using an operation part 27.

The Internet facsimile apparatus 1 is commonly used by a plurality of users, and a user who wants to have his or her own account can have an account with each user or each group of users. Moreover, the common account is used when a user transmits or receives data without specifying the account. The delivery table for the common account is also used for specifying a delivery destination when receiving facsimiles from the conventional facsimile machines such as G3 facsimile machine. Furthermore, a touch panel is provided with the operation part 27, the touch panel is overlapped with an LCD display of the display part 26. Thus, a list of accounts and receiving devices are shown on the LCD display, and users can specify the account and the destination of the purpose.

An account specification part 29 accepts the specification of a source account when transmitting a facsimile via the Internet by e-mail. More precisely, it accepts inputs from the touch panel and the specification of an account with the keyboard. The specified account then becomes a source account (e-mail address), and the common account becomes the source account when the account is not specified. Additionally, the common account is also set for the LAN manager, and a password can also be used for differentiating between general users and the LAN manager to limit access to the common account of general users. The common account for general users and a dedicated account for the manger can be set, instead of the common account commonly used by the manager and the general users in common.

An account registration part 30 accepts the registration of new accounts with the input of account names. The common account had already been set before shipping the Internet facsimile apparatus 1. The newly created account is set for each user. A start key 31 is provided for instructing the start of transmission, a scanner 32 is for reading images of a document, and a reference number 33 is a record part such as a printer.

An account management part 35, provided for managing an account, stores the list of accounts. Moreover, the account management part 35 manages a delivery table 36, a reception log 37, and a transmission log 38 of e-mails with each account. Additionally, the accounts can be logically or physically classified. Not shown in the figures, sources such as one-touch dial lists or e-mail address lists of receiving devices are also classified and managed with each account. For example, one-touch dial and the e-mail address lists for the source account are shown on a touch panel when specifying the source account, so that the receiving device can be easily input.

Data of a delivery destination to the common account in the delivery table 36 is used when receiving a facsimile via the Internet by the common account or when receiving a facsimile from a conventional facsimile machine such as G3 or G4 facsimile machines. The data includes an e-mail address and/or a facsimile number of the delivery destination (transfer destination) and the necessity of print process in the Internet facsimile apparatus 1. Likewise, delivery data in the delivery table 36 to the account for each user includes an e-mail address or facsimile number of transfer destination and the necessity of print process in the Internet facsimile apparatus 1. However, as the delivery destination when receiving a conventional facsimile is defined in the delivery table for the common account, the delivery destination when receiving a conventional facsimile does not need to record in the delivery table of account with each user.

A transmission/reception identification part 40 transmits data, when a document is set, destination (receiving device such as an e-mail address or facsimile number) is specified, and the start key 31 is pressed. When the start key 31 is pressed without setting a document on the scanner 32 and without inputting the destination from the keyboard 28, data is received manually from the mail server 3. Moreover, when the start key 31 is pressed after specifying the receiving device without setting a document, or when the start key 31 is pressed after setting a document without specifying the receiving device, a message “please set a document” or “please specify a receiving device” is shown on a display part 26. In the manual reception, all of the e-mails that are received by the mail server and unopened by the Internet facsimile apparatus are taken out from the mail box corresponding to the specified account or the mail box corresponding to the common account, when the account is not specified. And, all of the e-mails that were taken out are printed. A LAN Interface 42 is connected to the e-mail server 3 through the LAN 2.

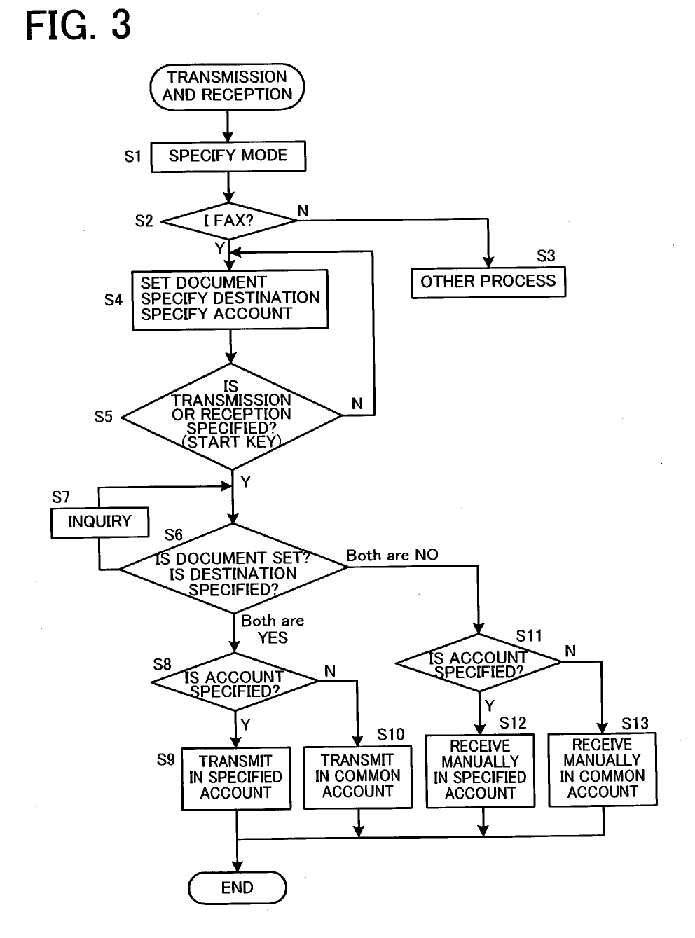

FIG. 3 shows a transmission and reception algorithm in the Internet facsimile apparatus in the preferred embodiment. In step 1, the Internet facsimile apparatus 1 accepts a mode specification of Internet facsimile mode or G3 facsimile mode. In step 2, it is checked whether it is an Internet facsimile mode or a G3 facsimile mode. When it is not an Internet facsimile mode, other process is carried in step 3. The other process will be described later. When it is an Internet facsimile mode, a document is set, a mail address of a receiving device is specified, and the specification of source account is accepted in step 4. When the account is specified, the list of receiving device addresses for the specified account is shown on a touch panel, and the receiving device can be set through one-touch operation. Moreover, the common account is set automatically when the source account is not specified. The specification can be changed anytime until the start key is pressed for transmitting or receiving data in step 5.

When the start key is pressed, the facsimile transmitting operation is carried out if a document is set in a scanner 32 and the receiving side is specified, and the facsimile receiving operation is carried out if a document is not set and the receiving device is not specified (step 6). When the receiving device is not specified though a document is set, or when a document is not set though the receiving device is specified, the message “please specify receiving device” or “please set a document” is shown on the display part in step 7 for urging users to specify the receiving device or to set a document. When transmitting a facsimile, the document is read, whether or not the account is specified is checked in step 8, and the facsimile is transmitted using the account specified in step 9 if the account is specified. Moreover, the facsimile is transmitted using the common account if the account is not specified. (Step 10)

When receiving a facsimile, whether or not the account is specified is checked in step 11, and the facsimile is received manually with the specified account. (Step 12) Moreover, the facsimile is received manually with the common account if the account is not specified. (Step 13) To receive a facsimile manually means to output (print) all of the e-mails already received but unopened from the mailbox corresponded to a predetermined account.

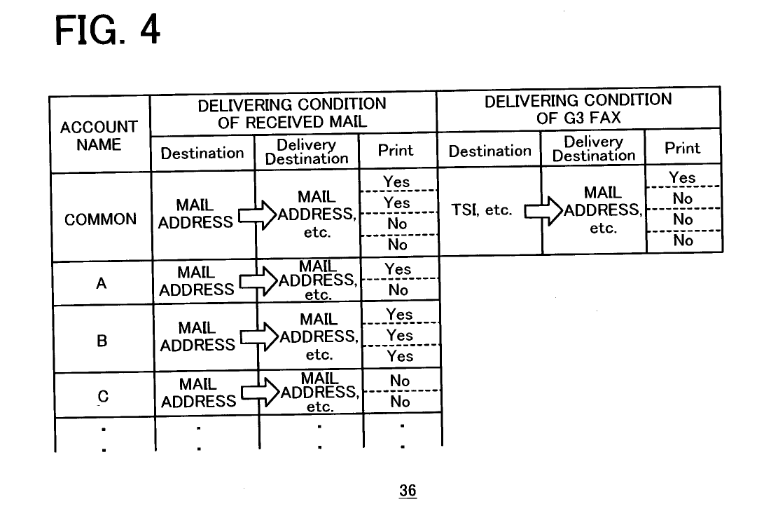

FIG. 4 shows an automatic reception process with each account. Data for determining an e-mail address and facsimile number of a delivery destination is listed in the delivery table with each account, based on information such as a source e-mail address of transmission. Besides, the necessity of print process in the Internet facsimile apparatus 1 is listed in the table. Thus, an e-mail address or facsimile number of the delivery destination and the necessity of print process is specified to the source defined in the delivery table. Moreover, the delivery destination is assigned a number greater than one. Additionally, whether to print automatically in the Internet facsimile apparatus 1 to the source of transmission not defined in the delivery table is also recorded in the delivery table with each account.

The other process in step 3 as illustrated in FIG. 3 is related to the transmission and reception of a facsimile such as a G3 facsimile, and the transmission of the G3 facsimile is not related to the account in particular. When a G3 facsimile is received, a TSI (sender identification code) or F code can be received. When an e-mail address or facsimile number of the delivery destination to the TSI or F code of the source of transmission is stored in a field of common account in the delivery table in advance, and accordingly the necessity of print process in the Internet facsimile apparatus is stored, the facsimile can be delivered automatically to a predetermined delivery destination with the common account, even if receiving the G3 facsimile.

What is claimed is:

1. An Internet facsimile apparatus, comprising:
a plurality of accounts;
means for setting at least one of the plurality of accounts as a common account;
means for accepting an indication of an account; and
means for transmitting and receiving e-mails;
wherein e-mails are transmitted and received with a specified account and the common account is used for the transmission and reception of e-mails when the account is not specified.

2. The Internet facsimile apparatus as in claim 1, wherein the common account is registered in advance.

3. The Internet facsimile apparatus as in claim 1, wherein the common account is set for a local area network (LAN) manager.

4. The Internet facsimile apparatus as in claim 1, further comprising means for accepting an account name and registering a new account.

5. The Internet facsimile apparatus as in claim 1, further comprising means for storing a list of accounts.

6. The Internet facsimile apparatus as in claim 5, further comprising a table wherein an e-mail address of a delivery destination is defined with each account of the list; and
means for delivering received e-mails to the e-mail address defined in the table when the means for transmitting and receiving e-mails receives an e-mail.

7. The Internet facsimile apparatus as in claim 6, further comprising means for transmitting and receiving facsimile data through a public switched telephone network (PSTN), wherein a delivery destination address of facsimile data received by the means for transmitting and receiving facsimile data is set in the table for common accounts, and the means for delivering delivers facsimile data received through the PSTN to the delivery destination address specified in the common account when the means for transmitting and receiving facsimile data receives the facsimile data.

8. The Internet facsimile apparatus as in claim 5, further comprising a table wherein a printing operation for the Internet facsimile apparatus is defined with each account of the list.

9. The Internet facsimile apparatus as in claim 5, further comprising means for storing an e-mail reception log with each account of the list.

10. The Internet facsimile apparatus as in claim 5, further comprising means for storing an e-mail transmission log with each account of the list.

11. The Internet facsimile apparatus as in claim 1, further comprising a scanner;
a start key for instructing to start an operation; and
means for extracting e-mails untaken from a mail box corresponding to an account set by the means for accepting or the common account without setting a document on the scanner and setting a sending destination when the start key is pressed.

12. An Internet facsimile apparatus, comprising:
a plurality of accounts;
means for setting at least one of the plurality of accounts as a common account;
means for accepting an indication of an account;
means for transmitting and receiving e-mails;
means for transmitting and receiving facsimile data;
means for delivering received e-mails or facsimile data to a delivery destination;
means for storing a list of accounts; and
a table wherein a delivery destination address of e-mails received by the means for transmitting and receiving e-mails is defined,
wherein a delivery destination address of the facsimile data received by the means for transmitting and receiving facsimile data is also stored in a table for common accounts, and e-mails are transmitted, received, or delivered with a specified account, the common account is used for the transmission or delivery of e-mails when the account is not specified, and the facsimile data is delivered to the e-mail address specified in the common account when the means for transmitting and receiving facsimile data receives the facsimile data.

13. The Internet facsimile apparatus as in claim 12, further comprising means for accepting an account name and registering a new account.

14. The Internet facsimile apparatus as in claim 12, further comprising:
a scanner;
a start key for instructing to start an operation; and
means for extracting e-mails untaken from a mail box corresponding to an account set by the means for accepting or the common account without setting a document on the scanner and setting a sending destination when the start key is pressed.

15. The Internet facsimile apparatus as in claim 12, wherein the common account is registered in advance.

16. The Internet facsimile apparatus as in claim 12, wherein the common account is set for a local area network (LAN) manager.

17. The Internet facsimile apparatus as in claim 12, further comprising a table wherein a printing operation for the Internet facsimile apparatus is stored with each account of the list.

18. The Internet facsimile apparatus as in claim 12, further comprising means for storing an e-mail reception log with each account of the list.

19. The Internet facsimile apparatus as in claim 12, further comprising means for storing an e-mail transmission log with each account of the list.

20. An Internet facsimile apparatus, comprising:
a scanner;
a start key for instructing to start an operation;
a plurality of accounts;
means for setting at least one of the plurality of accounts as a common account;
means for accepting an indication of an account;
means for transmitting and receiving e-mails;
means for delivering received e-mails to an e-mail address of a delivery destination;
means for storing a list of accounts;
a table wherein a delivery destination address of e-mails received by the means for delivering with each account of the list is defined; and
means for extracting untaken e-mails from a mail box corresponded to an account set by the means for accepting or the common account without setting a document on the scanner and setting a sending destination when the start key is pressed,
wherein e-mails are received and delivered with a specified account when the account is specified, and the common account is used for the reception and delivery of e-mails when the account is not specified.

21. The Internet facsimile apparatus as in claim 20, further comprising a means for receiving facsimile data, wherein a delivery destination address of the facsimile data received by the means for receiving facsimile data is defined in a table for common accounts, and the means for delivering delivers facsimile data to the delivery destination address set in the common account.

22. The Internet facsimile apparatus as in claim 20, further comprising means for accepting an account name and registering a new account.

23. The Internet facsimile apparatus as in claim 20, wherein the common account is registered in advance.

24. The Internet facsimile apparatus as in claim 20, wherein the common account is set for a local area network (LAN) manager.

25. The Internet facsimile apparatus as in claim 20, further comprising a table wherein a printing operation for the Internet facsimile apparatus is specified with each account of the list.

26. The Internet facsimile apparatus as in claim 20, further comprising means for storing an e-mail reception log with each account of the list.

27. The Internet facsimile apparatus as in claim 20, further comprising means for storing an e-mail transmission log with each account of the list.

28. A method of transmitting and receiving facsimiles by e-mail comprising:
accepting the indication of the account where a common account is made into a default value when transmitting and receiving e-mails; and
transmitting and receiving e-mails with a specified account when the account is specified and also with a common account when the account is not specified.

29. The method of transmitting and receiving facsimiles by e-mail as in claim 28, further comprising registering the common account in advance.

30. The method of transmitting and receiving facsimiles by e-mail as in claim 28, further comprising setting the common account for a local area network (LAN) manager.

31. The method of transmitting and receiving facsimiles by e-mail as in claim 28, further comprising accepting input of an account name and registering a new account.

32. The method of transmitting and receiving facsimiles by e-mail as in claim 28, further comprising storing a list of accounts.

33. The method of transmitting and receiving facsimiles by e-mail as in claim 32, further comprising defining a delivery destination with each account of the list; and
delivering received e-mails to a delivery destination address set in a table when e-mails are received.

34. The method of transmitting and receiving facsimiles by e-mail as in claim 33 further comprising:
receiving facsimile data through a public switched telephone network (PSTN); and
delivering the received facsimile data to a delivery destination address set in the common account when facsimile data is received.

35. The method of transmitting and receiving facsimiles by e-mail as in claim 32, further comprising storing a printing command with each account of the list.

36. The method of transmitting and receiving facsimiles by e-mail apparatus as in claim 32, further comprising memorizing an e-mail reception log with each account of the list.

37. The method of transmitting and receiving facsimiles by e-mail as in claim 32, further comprising memorizing an e-mail transmission log with each account of the list.

38. The method of transmitting and receiving facsimiles by e-mail as in claim 28, further comprising taking out e-mails untaken from a mail box corresponding to an account specified or a common account without setting a document on a scanner and setting a sending destination when a start key is pressed.

39. An Internet facsimile apparatus comprising:
an account specification device that accepts at least one of a plurality of accounts set in the Internet facsimile apparatus as a common account and also accepts a default value as the common account; and
a communication device that transmits and receives e-mails wherein e-mails are transmitted and received with a specified account and the common account is used for the transmission of e-mails when the account is not specified.
